(19) United States
(12) Patent Application Publication
(10) Pub. No.: US 2025/0262906 A1
(43) Pub. Date: Aug. 21, 2025

(54) HVAC BOX FOR COOLING COMPONENTS OF A VECHICLE

(71) Applicant: TI Automotive Technology Center GmbH, Rastatt (DE)

(72) Inventor: Sebastian BRIXNER, Rastatt (DE)

(21) Appl. No.: 19/056,170

(22) Filed: Feb. 18, 2025

(30) Foreign Application Priority Data
Feb. 19, 2024 (EP) 24158420.0

(51) Int. Cl. B60H 1/00

(52) U.S. Cl. CPC B60H 1/0055; B60H 1/00328; B60H 1/00521; B60H 1/00564; B60H 1/00571

(57) ABSTRACT

An HVAC box for cooling components of a vehicle with a coolant, having a box with integrated coolant pipes, a first mounting flange for a coolant pump, and a second mounting flange for a coolant valve. The first and second mounting flanges are connected with at least one coolant pipe.

### RELATED APPLICATIONS

The present disclosure claims priority to and the benefit of European Application 24158420.0, filed on Feb. 19, 2024, the entire contents of each of which are incorporated herein by reference.

### FIELD

The disclosure relates to a heating, ventilation and air conditioning (HVAC) box for conditioning the cabin and cooling components of a vehicle, in particular an electric vehicle.

### BACKGROUND

In the related art the HVAC box is arranged close to the bulkhead outside the cabin. The HVAC box has to be arranged close to the air outlets by which heated or cooled air is conducted to the cabin of the car. In modern cars this space is needed for other components such as components for autonomous driving and head up displays.

### BRIEF SUMMARY

The present disclosure teaches the movement of the thermal components of a vehicle HVAC box to another location and to enable arrangement of these components in a more flexible manner.

The inventive HVAC box serves at the same time as a classical HVAC box, preferably according to the definition below, and for cooling components of a vehicle, in particular an electric vehicle with a coolant. The HVAC box comprises: a box, in particular a plastic box with integrated coolant pipes, a first mounting flange for a coolant pump and a second mounting flange for a coolant valve. The first and second mounting flange are connected with at least one coolant pipe.

The inventive HVAC box has the advantage that it serves for conducting air while at the same time it provides a mounting flange for a coolant pump and a mounting flange for a coolant valve. Therefore, all these components can be arranged in a very compact manner on the HVAC box. Further this HVAC box can be arranged in a very flexible manner inside the vehicle and therefore, can be moved away from the bulkhead of the vehicle where other components such as a head up display or components for autonomous driving can be arranged instead. Considering a conditioning of the cabin via the vehicle ceiling and/or floor instead of via dashboard nozzles, as it would be applied in autonomous driving vehicles for the case that the front passengers are facing the rear passengers, the HVAC box can be relocated and merged with the thermal management system of the vehicle, making valuable space near the bulkhead.

An HVAC box in a car, also known as the HVAC module or heater box, is a component of the vehicle's heating, ventilation, and air conditioning (HVAC) system. It serves for regulating and directing airflow, temperature, and air distribution within the cabin.

The HVAC box may house essential components such as the heater core, evaporator, blower motor, blend doors, and/or actuators. It preferably controls the mixing of hot and cold air, adjusts airflow direction (defrost, floor, face vents), and/or ensures proper climate control based on user settings. The system works by drawing air from outside or inside the vehicle, conditioning it (heating or cooling), and then distributing it through ducts to the cabin.

It is preferred that a heat exchanger is attached to the HVAC box.

It is further preferred that the coolant pipes are integrally formed in the HVAC box by blow molding or injection molding.

In a further preferred embodiment the inventive apparatus comprises a second heat exchanger, which is tilted relative to the first heat exchanger. In other words the two heat exchangers are not arranged parallel to each other.

It is preferred that the first heat exchanger is adapted to transfer heat between the coolant and air, whereby this air is distributed by airducts which are attached to the heat exchanger.

It is further preferred that the second heat exchanger is adapted to transfer heat between the refrigerant and/or coolant and air.

The inventive apparatus may further comprise a refrigerant module attached to the HVAC box, whereby a chiller is attached to the HVAC box for exchanging heat between the refrigerant and the coolant.

The refrigerant module manages the functions of air conditioning, drying and heat pump by controlling refrigerant flow and pressure to the HVAC refrigerant-air heat exchangers (evaporator, condenser/gas cooler) as well as to the attached refrigerant-coolant heat exchangers (chiller, liquid cooled condenser), for battery conditioning or heat harvesting. The module comprises flow channels embedded in an aluminum module as well as valves, sensors, filling ports and interfaces to lines and heat exchangers.

The refrigerant module can be embedded into the integrated HVAC box or attached to it via interfaces at the commonly shared components, such as the first or second heat exchanger or the refrigerant-coolant heat exchanger (chiller, liquid cooled condenser).

The refrigerant-coolant heat exchangers comprise flow connections to the coolant as well as to the refrigerant module or equivalent piping, while allowing large heat transfer between both fluids by providing a large surface area, e.g. as a stack of brazed plates.

It is further preferred that the pipes of the chiller, in which the coolant flows, are integrally formed in the HVAC box.

It is further preferred that the airducts, which are used to distribute the air coming from the first heat exchanger, are arranged in the A, B and/or C pillars of the vehicle and/or in the vehicle roof.

It is further preferred that at least a part of the airducts is insulated. Hereby, thermal losses can be minimised so that the airducts can be longer without wasting too much heat.

### BRIEF DESCRIPTION OF THE DRAWINGS

The following figures describe preferred embodiments of the present disclosure.

FIGS. 1-7 show an embodiment of the present disclosure from different perspectives.

### DETAILED DESCRIPTION

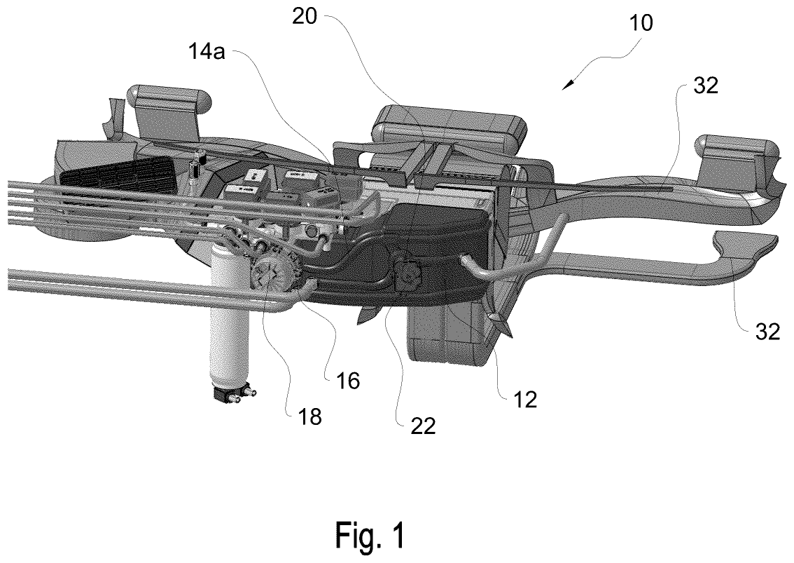

FIG. 1 shows the inventive HVAC box 10 for cooling components of a vehicle, in particular an electric vehicle, with a coolant, while at the same time it serves as a classical HVAC box according to the functions described above. The HVAC box 10 comprises a plastic box 12 with integrated coolant pipes 14a. These can be for example blow molded and therefore, be integrally formed in the plastic box 12. The plastic box 12 comprises a first mounting flange 16 for a coolant pump 18 and a second mounting flange 20 for a coolant valve 22. The coolant pump is used for pumping the coolant to other components of the vehicle. The coolant valve is used for facilitating the distribution of the coolant inside the vehicle.

The first and second mounting flanges 16, 20 are connected with at least one coolant pipe 14a-14d, which is integrally formed in the plastic box 12.

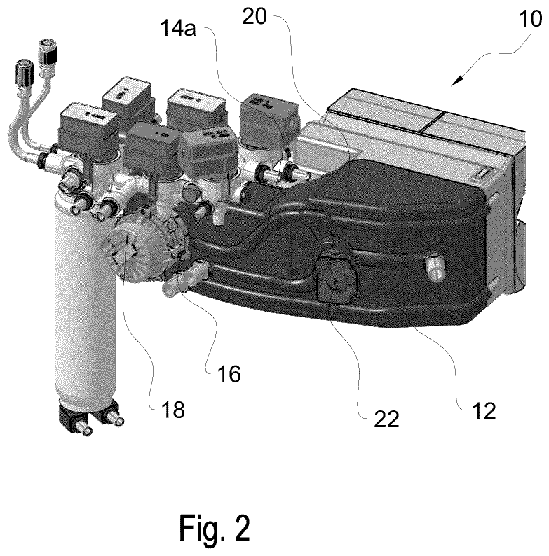

The HVAC box 10 is shown in an isolated view in FIG. 2 whereas FIG. 1 shows the HVAC box together with other components, e.g. airducts 32.

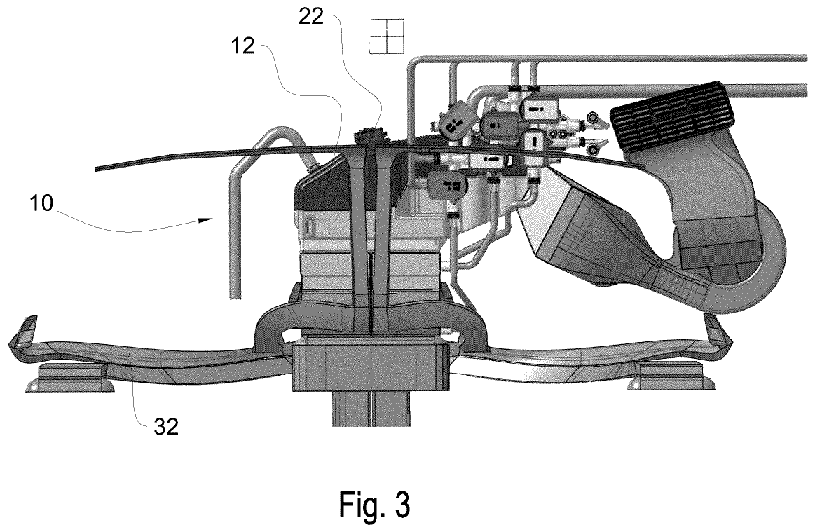

FIG. 3 shows the HVAC box 10 of FIG. 1 from above. In particular it can be seen how the air coming from the first heat exchanger 24 is distributed via airducts 32.

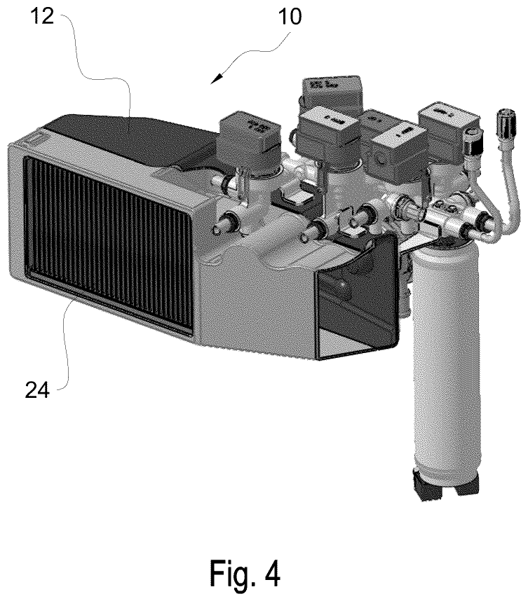

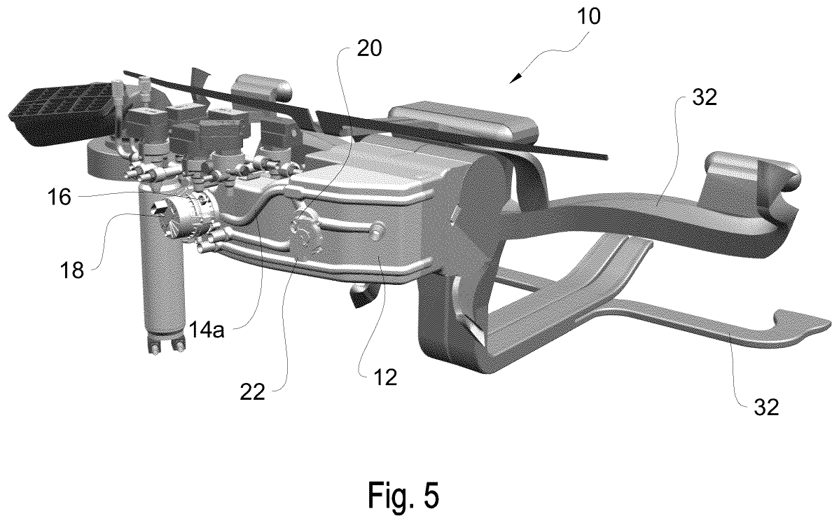

This first heat exchanger 24 is shown in FIG. 4. The airducts are also shown in FIG. 5.

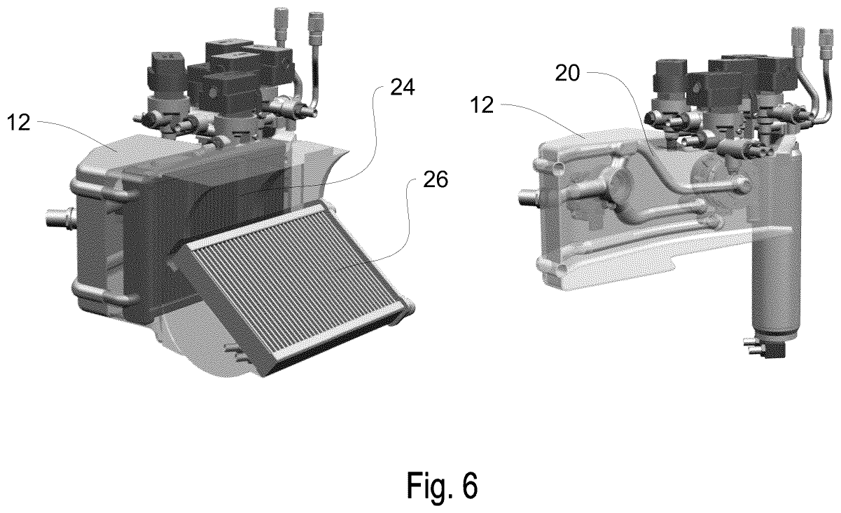

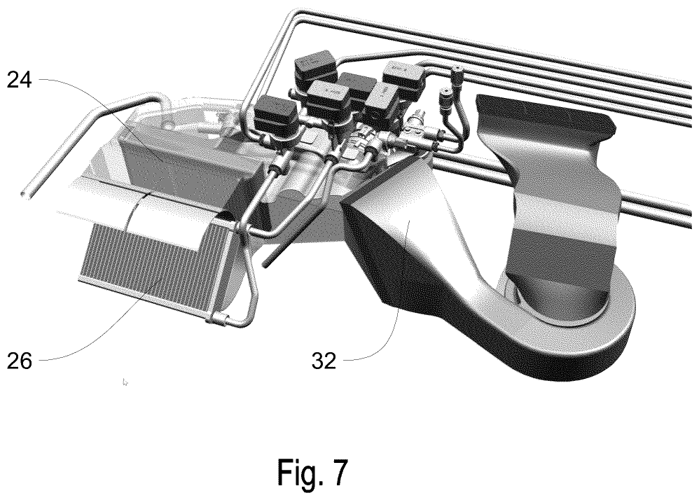

FIG. 6 shows the first heat exchanger 24 and the second heat exchanger 26, which is tilted relative to the first heat exchanger 24. The first heat exchanger 24 is adapted to transfer heat between the coolant and air, whereby this air is distributed by air ducts 32 which are attached to the heat exchanger (see e.g. FIG. 5). The second heat exchanger 26 is adapted to transfer heat between the refrigerant and air.

The function of the system components is as follows.

pT Sensors are used to measure the pressure and/or temperature inside the fluid. They are used in coolant and refrigerant circuits.

Valves are used to distribute the flow between various channels or precisely control the mass flow rate or pressure in each flow path. Various types can be used in the coolant and refrigerant circuits.

The accumulator stores liquid refrigerant, separates gas and liquid phase, ensures oil return to the compressor and extracts moisture out of the system.

The internal heat exchanger (embedded in accumulator) exchanges heat between liquid and suction line of the refrigerant system to increase system efficiency.

The disclosure is further related to a cooling module for cooling components of a vehicle as described in the following aspects below. Here the cooling module is equivalent to the HVAC box as described in the specification above and may comprise identical features:

### Aspects

A first aspect is a cooling module for cooling components of an vehicle with a coolant, the cooling module having a box with integrated coolant pipes, a first mounting flange for a coolant pump, a second mounting flange for a coolant valve, and whereby the first and second mounting flanges are connected with at least one coolant pipe.

According to another aspect, a heat exchanger is a attached to the cooling module.

According to another aspect, the coolant pipes are integrally formed in the cooling module by blow molding.

According to another aspect, a second heat exchanger tilted relative to the first heat exchanger so that the two heat exchangers are not arranged parallel to each other.

According to another aspect, a refrigerant module attached to the cooling module, whereby a chiller is attached to the cooling module for exchanging heat between the refrigerant and the coolant.

According to another aspect, the pipes of the chiller to which the coolant flows are integrally formed in the cooling module.

According to another aspect, the heat exchanger is adapted to transfer heat between the coolant and air, whereby this air is distributed by air ducts, which are attached to the heat exchanger.

According to another aspect, the second heat exchanger is adapted to transfer heat between the refrigerant and air.

According to another aspect, the air ducts are arranged in the A, B and/or C-pillars of the vehicle and/or in the vehicle roof.

According to another aspect, at least a part of the air ducts is insulated.

1. An HVAC box for cooling components of a vehicle with a coolant and/or refrigerant, the HVAC box comprising:
a box with integrated coolant pipes,
a first mounting flange for a coolant pump,
a second mounting flange for a coolant valve, and
whereby the first and second mounting flanges are connected with at least one coolant pipe.

2. The HVAC box according to claim 1, wherein a heat exchanger is attached to the HVAC box.

3. The HVAC box according to claim 1, wherein the coolant pipes are integrally formed in the HVAC box by blow molding and or injection molding.

4. The HVAC box according to claim 2, further comprising a second heat exchanger tilted relative to the first heat exchanger so that the two heat exchangers are not arranged parallel to each other.

5. The HVAC box according to claim 1, further comprising a refrigerant module attached to the HVAC box, whereby a chiller is attached to the HVAC box for exchanging heat between the refrigerant and the coolant.

6. The HVAC box according to claim 5, wherein the pipes of the chiller to which the coolant flows are integrally formed in the HVAC box.

7. The HVAC box according to claim 2, wherein the heat exchanger is adapted to transfer heat between the coolant and air, whereby this air is distributed by air ducts, which are attached to the heat exchanger.

8. The HVAC box according to claim 4, wherein the second heat exchanger is adapted to transfer heat between the refrigerant and air.

9. The HVAC box according to claim 7, wherein the air ducts are arranged in the A, B and/or C-pillars of the vehicle and/or in the vehicle roof.

10. The HVAC box according to claim 9, wherein at least a part of the air ducts is insulated.
